(19) United States
(12) Patent Application Publication
(10) Pub. No.: US 2021/0042748 A1
(43) Pub. Date: Feb. 11, 2021

(54) BLOCKCHAIN-BASED SECURE RESOURCE MANAGEMENT

(71) Applicant: American Lebanese Syrian Associated Charities, Inc., Memphis, TN (US)

(72) Inventors: Marc Gordon Sepulveda, Memphis, TN (US); Kenneth Adam Zakalik, Memphis, TN (US); Brandon Wesley Thornburg, Memphis, TN (US)

(73) Assignee: American Lebanese Syrian Associated Charities, Inc., Memphis, TN (US)

(21) Appl. No.: 16/987,611

(22) Filed: Aug. 7, 2020

Related U.S. Application Data
(60) Provisional application No. 62/883,737, filed on Aug. 7, 2019.

(51) Int. Cl. G06Q 20/38; H04L 9/06; H04L 29/06; G06Q 20/36

(52) U.S. Cl. CPC G06Q 20/38215; H04L 9/0637; G06Q 2220/00; G06Q 20/36; H04L 2209/38; H04L 67/40

(57) ABSTRACT

Systems and methods for secure resource management are provided. A secure resource management system includes a blockchain-based computing network configured to host a blockchain for generating a digital object to represent a resource associated with a physical object and transferring the digital object to a secure network address associated with a user. The secure resource management system further includes a database configured for storing data in the blockchain and a services layer system for communicating with the blockchain and the database by requesting the blockchain to generate the digital object, storing the identifier of the digital object in the database, requesting the blockchain to transfer the digital object to a secure network address associated with a user and updating the database to indicate that the digital object is assigned to the user.

### CROSS-REFERENCE TO RELATED APPLICATIONS

This claims priority to U.S. Provisional Application No. 62/883,737, filed on Aug. 7, 2019, which is hereby incorporated in its entirety by this reference.

### TECHNICAL FIELD

This disclosure relates generally to increasing the security of resource management by preventing fraudulent access to resources using blockchain-based resource management.

### BACKGROUND

Resource management, or more specifically resource access control, becomes more and more challenging as various resources now can be conveniently acquired, accessed, and transferred online. For example, a user can acquire an online storage resource through online transactions with a resource provider of the online storage resource, and the user can access the online storage resource over the Internet. If the user later decides that the user no longer needs the online storage resource, the user can transfer the unused term of the online storage resource to another user or entity, again through online transactions with the other user or entity. The online nature of the resource access and transfer eases fraudulent accesses of the resources and contributes to a significant threat faced by resource providers.

### SUMMARY

Various aspects of the present disclosure involve providing a blockchain-based secure resource management system to prevent fraudulent resource access. In one example, a secure resource management system includes a blockchain-based computing network configured to host a blockchain. The blockchain is configured for generating, based on information about a physical object, a digital object to represent a resource associated with the physical object, and responsive to a transfer request, transferring the digital object to a secure network address associated with a user indicated in the transfer request. The secure resource management system further includes a database configured for storing at least identifiers of digital objects created by the blockchain-based computing network along with information about respective physical objects, and a services layer system communicatively coupled to the blockchain-based computing network and the database. The services layer system is configured for performing operations comprising sending information about the physical object to the blockchain in the blockchain-based computing network to request the digital object to be generated; receiving, from the blockchain, an identifier of the digital object created on the blockchain; and storing the identifier of the digital object in the database along with the information about the physical object. The operations further include receiving, through a user interface presented on a user computing device associated with a user, a request for obtaining the digital object by the user; in response to receiving the request, sending a transfer request to the blockchain to cause the blockchain to transfer the digital object to a secure network address associated with the user; and updating the database to indicate that the digital object is assigned to the user.

In another example, a method that includes one or more processing devices performing operations that include sending information about a physical object to a blockchain to cause a digital object to be created to represent a resource associated with the physical object on the blockchain; receiving an identifier of the digital object created on the blockchain; storing the identifier of the digital object in a database along with the information about the physical object; receiving, through a user interface presented on a user computing device associated with a user, a request for obtaining the digital object by the user; in response to receiving the request, causing the blockchain to transfer the digital object to a secure network address associated with the user; and updating the database to indicate that the digital object is assigned to the user.

In a further example, a system includes one or more processing devices, and a non-transitory computer-readable storage medium communicatively coupled to the processing device. The one or more processing devices are configured to execute program code stored in the non-transitory computer-readable storage medium and thereby perform operations comprising: sending information about a physical object to a blockchain to cause a digital object to be created to represent a resource associated with the physical object on the blockchain; receiving an identifier of the digital object created on the blockchain; storing the identifier of the digital object in a database along with the information about the physical object; receiving, through a user interface presented on a user computing device associated with a user, a request for obtaining the digital object by the user; in response to receiving the request, causing the blockchain to transfer the digital object to a secure network address associated with the user, and updating the database to indicate that the digital object is assigned to the user.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

### BRIEF DESCRIPTION OF THE DRAWINGS

The foregoing, together with other features and examples, will become more apparent upon referring to the following specification, claims, and accompanying drawings.

FIG. 1 depicts an example of a blockchain-based resource management system for managing the resources associated with physical objects, according to certain aspects of the present disclosure.

FIG. 2 is a flowchart depicting an example of a process for creating digital objects for physical objects in the blockchain, according to certain aspects of the present disclosure.

FIG. 3 is a flowchart showing an example of a process for facilitating resource acquisition through the blockchain-based resource management system, according to certain aspects of the present disclosure.

FIG. 4 is a block diagram depicting an example of a computing system suitable for implementing aspects of the techniques and technologies presented herein.

### DETAILED DESCRIPTION

Certain aspects of this disclosure describe managing resources associated with physical objects using a blockchain-based system. A digital object, such as a digital token, is created for each physical object with which the resource is associated. The digital object represents the resource associated with the physical object, such as a storage resource associated with a storage server, computing resources associated with a computing server, or rights associated with a physical item. A user can acquire the resource associated with a physical object by acquiring the corresponding digital object in the blockchain. The statuses of the digital objects associated with physical objects are maintained in a blockchain (e.g., through a smart contract executing on the blockchain) in a blockchain-based computing network, such as a hyperledger fabric network or an ethereum network.

Operations involving acquiring and transferring the resources are carried out by acquiring and transferring the corresponding digital objects. The acquisition of the digital objects and the transfer of the digital objects are performed using the blockchain in the blockchain-based computing network to maintain the integrity and security of the operations. The blockchain is exposed via a representational state transfer (RESTful) service abstraction layer so that the blockchain can be digested and utilized by legacy and future systems. The RESTful service abstraction layer provides interoperability between computer systems on the Internet. RESTful Web services allow the requesting systems to access and manipulate textual representations of Web resources by using a uniform and predefined set of stateless operations. This may provide a scalable interface for developers to interact with the blockchain without extensive knowledge or expertise in blockchain technologies.

In addition, a secured non-blockchain operational database is employed to store data maintained in the blockchain. As a result, information stored in the blockchain can be efficiently retrieved from the operational database rather than the blockchain itself. Services derived from legacy asset management systems are also utilized to efficiently import data about the physical objects into the system. Once imported, the system creates a digital object for each of the physical objects to generate a one-to-one correspondence between the digital and physical objects. The system is configured to allow a user to acquire the digital object. Likewise, the system also allows transfers of resources, such as the corresponding digital objects, among users, although the ownership of the physical objects remains unchanged. The digital object can also be destroyed when the resources associated with a physical object are no longer available.

The system further integrates blockchain wallets of the user into the resource management system. When acquiring resources associated with a physical object, a user can log in to the system and access the user's blockchain wallet without a third-party application. If a user does not have a blockchain wallet, the system will create one for the user that is integrated with the system. In other words, no separate authentication needs to be performed for accessing the blockchain wallets of the users once the users have been authenticated through the resource management system. Information, such as the information about acquired or subsequently acquired digital objects or information about the physical object associated with the digital objects can be stored in the blockchain wallet for access by the user.

As described herein, certain aspects provide improvements to resource management by solving the fraudulent access problems that are specific to the Internet. As discussed above, the online nature of resource access and transfer makes the fraudulent access of the resources easier to occur and harder to detect. The centralized secure resource management system in the present disclosure keeps track of each transaction regarding a resource and maintains a secured copy of the records in a secure repository such as a blockchain and a secure database. This allows the authenticity of the resource and the authorized user to be verified whenever needed. By utilizing secure computer technologies, such as the blockchain, this secure resource management solution significantly reduces the chances of fraudulent access to resources.

In addition, the secure resource management system presented herein also improves the efficiency of accessing the information on the blockchain by storing the information in a secured database. Compared with retrieving information from the blockchain, retrieving from the secured database can be performed much faster with less network and computing resource consumptions.

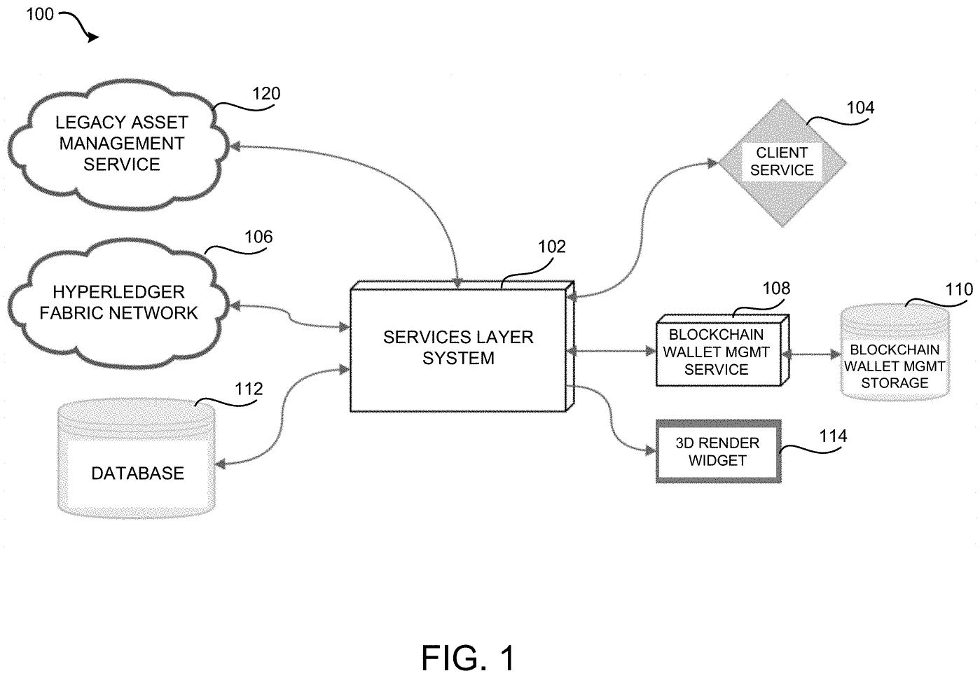

FIG. 1 depicts an example of a blockchain-based resource management system 100 that manages the resources associated with physical objects, according to certain aspects of the present disclosure. The resource associated with a physical asset can be, for example, computational resources associated with a computing device, storage resource associated with a storage device, naming rights of the physical item, and so on. In the following, naming rights are used as an example of the resource associated with the physical asset/object. The technologies presented herein can also be applied to other types of resources.

A digital object is created to represent the resource associated with a corresponding physical asset/object. The blockchain-based resource management system 100 assigns the resource associated with a physical object to a user by assigning the digital object corresponding to the physical object to the user based on the user's interaction with the system. The blockchain-based resource management system 100 includes a services layer system 102 that facilitates various transactions involving the digital objects through interacting with and integrating multiple systems or services, including a legacy asset management service 120, a hyperledger fabric network 106, an operational database 112, a client service 104, a blockchain wallet management service 108, and a 3D render widget 114. The various services or systems in the blockchain-based resource management system 100, such as the services layer system 102, the legacy asset management service 120, the client service 104, the blockchain wallet management service 108, and the 3D render widget 114 may be implemented using software (e.g., code, instructions, program) executed by one or more processing units (e.g., processors, cores, devices), hardware, or combinations thereof. In some implementations, the interaction between the services layer system 102 and other systems, such as the legacy asset management service 120, the operational database 112, the client service 104, the blockchain wallet management service 108, and the 3D render widget 114 are performed through a RESTful web service. As a result, these services or systems can interact with the blockchain in the hyperledger fabric network 106 without extensive knowledge or expertise in blockchain technologies.

The legacy asset management service 120 is able to obtain and maintain asset information about the physical assets/objects whose associated resources are offered for acquisition. The physical assets/objects can include, for example, devices, servers, buildings, rooms, labs, furniture, tools, etc. The information about the physical assets/objects can include, for example, the name, serial number, type, quantity, value, or any combination thereof of each of the physical assets. The legacy asset management service 120 can include an existing system maintaining asset information about the physical assets, such as a database or spreadsheets showing the asset information. In another example, the legacy asset management service 120 functions as an interface to an inventory system to obtain the asset information about the physical assets. In some implementations, the legacy asset management service 120 is further able to modify the asset information or cause the asset information to be modified at the request of the services layer system 102, such as adding a new item into the inventory of the physical assets or generating new information for an existing physical asset. Such a modification to the asset information may be accompanied by the actual addition of the new physical asset to the inventory.

The hyperledger fabric network 106 may host a blockchain for a smart contract developed for the blockchain-based resource management system 100. The smart contract includes computer program codes and is deployed to multiple nodes in the hyperledger fabric network 106 so that each of these nodes have a copy of the smart contract. When the smart contract is called at a specific address, the smart contract initiates the validation process across all the nodes on the blockchain so that the information kept by the nodes of the blockchain is consistent.

The smart contract may generate the digital objects for the physical assets and assist with the transactions of acquiring and transferring digital objects. For each physical asset in the inventory, the smart contract creates a digital object, such as a token, in the blockchain and records the token in the blockchain. The smart contract also keeps a record of the digital objects that each user owns. If there is a transaction involving a token, such as an acquisition of a token by a user or a transfer of a token from one user to another, the smart contract will be executed on each of the nodes to reflect such a transaction and to update the records of the token.

The operational database 112 may securely store a copy of the information that is stored in the smart contract such that the information can be retrieved directly from the operational database 112. Generally, retrieving information from the smart contract relies on the nodes in the hyperledger fabric network 106 to perform various operations or execute various codes in order to obtain the requested information. Those operations would slow down the retrieval process and thus cause a delay. As such, retrieving data from the operational database 112 is more efficient than retrieving data from the smart contract running in the hyperledger fabric network 106.

For example, the operational database 112 can store identification (ID) for each of the digital objects existing in the smart contract in the hyperledger fabric network 106. The operational database 112 can further store an owner list including the users who own the digital objects in the smart contract. The operational database 112 can also store an address list including the addresses of the blockchain wallets that store the acquired digital objects. Associations between emails and blockchain wallets of users can also be stored in the operational database 112. Other information that is not in the smart contract in the hyperledger fabric network 106, such as the session information for a website presented at the client service 104, can also be stored in the operational database 112. The operational database 112 is updated whenever there is a change in the smart contract, such as when new digital objects are created for physical assets, when transactions occur in the smart contract involving the digital objects, when a digital object is no longer available, and so on.

The client service 104 may present a user interface so that the users can interact with the blockchain-based resource management system 100 to acquire, transfer, or otherwise deal with the digital tokens stored in the smart contract. In some examples, the client service 104 is implemented as a web-based application that can be accessed by users through a web browser. To present a web-based application to the user, the services layer system 102 is configured to expose a RESTful web service to the client service 104 so that a user can interact with the smart contract through the RESTful web service. In other examples, the client service 104 is implemented as a standalone application.

A user can register for an account through the client service 104 and login to the blockchain-based resource management system 100 to conduct transactions involving digital tokens and manage the digital tokens that the user has acquired. The user can also browse through available physical assets for the acquisition of resources such as the naming rights through the client service 104. If the user decides to acquire the resources associated with a physical asset, the user can purchase the corresponding digital token in the smart contract through the client service 104. The purchase can be performed using a cryptocurrency, such as bitcoins, or an official currency issued by a country, such as US dollars. Once the purchase request is received, the client service 104 communicates with the services layer system 102 so that the transaction can be sent to the smart contract for execution. After the transaction is complete, the smart contract returns the results of the transaction, a copy of which is saved in the blockchain and also in the operational database 112. Based on the transition results, the operational database 112 also updates its record to reflect the new owner of the digital token involved in the transaction.

The services layer system 102 further communicates with the blockchain wallet management service 108 to facilitate the digital token transaction. The blockchain wallet management service 108 may create new blockchain wallets for users or import existing blockchain wallets of the users for use in the blockchain-based resource management system 100. A blockchain wallet is required for a user to acquire digital tokens in the blockchain-based resource management system 100. A blockchain wallet of a user includes a public address and a private key. The public address is where the user can claim ownership of the digital tokens he has acquired, and the public address can serve as the user's identity. The private key is used to access the wallet for various operations, such as adding or removing digital tokens from the wallets. For new blockchain wallets created in the blockchain-based resource management system 100, the private keys are also provided to users so that the users can access their respective blockchain wallets even if the blockchain-based resource management system 100 is unavailable.

In some embodiments, accessing the blockchain wallets is integrated with accessing the client service 104 (and thus the blockchain-based resource management system 100). As a result, no separate authentication is required to access the blockchain wallets. This can be achieved by the user providing the public address and a copy of the private key of his blockchain wallet to the blockchain wallet management service 108. With the private key of the blockchain wallet, the blockchain-based resource management system 100 can transparently operate on the blockchain wallet on the user's behalf. Eliminating the separate authentication for the blockchain wallet can reduce the computing resource consumption at the blockchain-based resource management system 100 and also reduce the response time to users' requests for interacting with the digital tokens.

Further, by integrating the authentication process of the blockchain-based resource management system 100 and the blockchain wallet, the user can access the blockchain wallet without using a third-party application, such as the MetaMask. In some cases, the client service 104 may examine if the user has a third-party application installed on the user's computing device. If so, the client service 104 can prompt the user to log into the third-party application and pass the login information to the blockchain wallet management service 108 so that the blockchain-based resource management system 100 can operate on the user's blockchain wallet on the user's behalf.

In some examples, the blockchain wallet management service 108 is further connected to a wallet management storage device 110. The wallet management storage device 110 may store information about the blockchain wallets of users, such as the public addresses of the blockchain wallets, the private keys of the blockchain wallets, and emails associated with the blockchain wallets. Other information related to the blockchain wallets may also be stored in the wallet management storage device 110.

The 3D render widget 114 may render a 3D model of the physical asset associated with a digital token. For example, if the resource is naming rights of a physical asset, a user, after logging into the system, can request to view the 3D model of the physical asset for which the user has acquired the naming rights to have a visual impression of the physical asset. The 3D model can be generated to show the physical object and any marker, such as plaque, indicating the naming rights of the user. The generation of the 3D model and the marker can be performed by following business rules, such as a marker is generated for a large item (e.g., for a chair or a table), but not for a small item (e.g., a lab tool, and so on).

In this example, the 3D render widget 114 can retrieve data about the requested physical assets from the services layer system 102. The services layer system 102 can obtain the data, such as the owner of the physical asset, the token associated with the physical asset, etc. from the smart contract executing in the hyperledger fabric network 106. Alternatively, the services layer system 102 can communicate with the operational database 112 to retrieve such data with lower resource consumption since the operational database 112 has a copy of all the information stored in the smart contract. The retrieval can be performed more efficiently by using the ID of the digital tokens, rather than the inventory list. With the data about the physical asset, the 3D render widget 114 can generate the 3D model and the marker using any 3D modeling techniques known in the art.

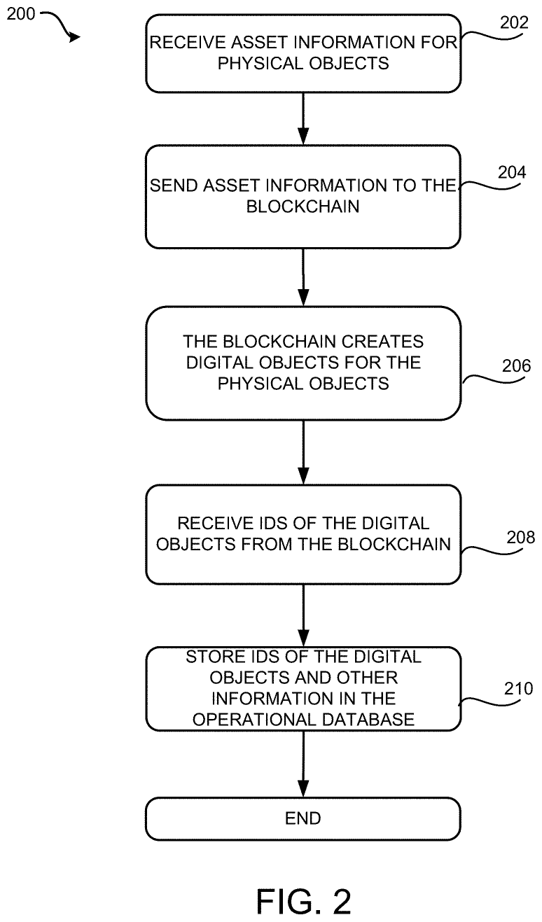

FIG. 2 is a flow chart depicting an example of a process 200 for creating digital tokens for physical assets in the blockchain, according to certain aspects presented herein. One or more computing devices (e.g., the devices implementing the blockchain-based resource management system 100 or, more specifically, the services layer system 102 and the smart contract in the hyperledger fabric network 106) implement operations depicted in FIG. 2 by executing suitable program code. For illustrative purposes, the process 200 is described with reference to certain examples depicted in the figures. Other implementations, however, are possible.

At block 202, the process 200 involves receiving asset information of the physical assets at the blockchain-based resource management system 100. In order for the blockchain-based resource management system 100 to manage the resources associated with the physical assets, information about physical assets is input to the blockchain-based resource management system 100. This information can be imported into the blockchain-based resource management system 100 through, for example, the legacy asset management service 120. Importing the asset information can be performed by the legacy asset management service 120 calling the services layer system 102, such as through a RESTful web service, to transmit the asset information.

At block 204, the process 200 involves sending the asset information to the blockchain (e.g., a smart contract on the blockchain) executing in the hyperledger fabric network 106. The services layer system 102 can call the blockchain, such as a smart contract on the blockchain, at its specific address to send the asset information about the physical assets one by one. At block 206, the blockchain (e.g., the smart contract stored on the blockchain), after receiving the asset information, creates a digital token for each physical asset listed in the asset information. The blockchain also stores the asset information therein. At block 208, the services layer system 102 receives an identifier (ID) for each of the generated digital tokens from the smart contract. At block 210, the services layer system 102 updates the operational database 112 with the returned IDs of the digital tokens. Because the digital tokens are newly created and have not been acquired by any user, the owner list stored in the operational database 112 does not include the owners of these digital tokens. Further, the address list (i.e., the addresses of the wallets) associated with these digital tokens are also empty or set to a default initial value, such as 0.

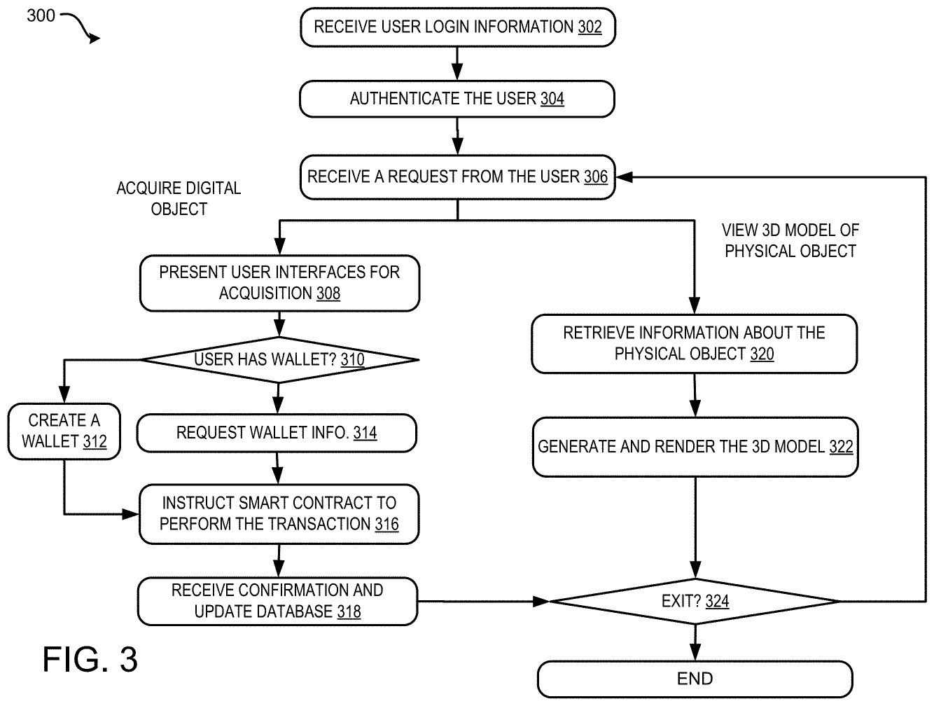

FIG. 3 is a flowchart showing an example of a process 300 for facilitating resource acquisitions through the blockchain-based resource management system 100, according to certain aspects presented herein. One or more computing devices (e.g., devices implementing the blockchain-based resource management system 100, or more specifically, the services layer system 102) implement operations depicted in FIG. 3 by executing suitable program code.

At block 302, the process 300 involves receiving a login request and login information from a user through the client service 104. At block 304, the process 300 involves authenticating the user using the login information provided by the user. Once the authentication of the user is successful, the services layer system 102 instructs the client service 104 to grant the user permission to access the blockchain-based resource management system 100. Note that if the user has previously created a blockchain wallet or has imported the user's blockchain wallet into the system, the authentication also authorizes the user to access the blockchain wallet. After being granted access, the user can navigate through the various functionalities provided by the blockchain-based resource management system 100, such as browsing through the information about the physical assets offered for resource acquisition.

At block 306, the process 300 involves receiving a request from the user. If the user's request is for acquiring the resource associated with a physical asset (i.e., acquiring the corresponding digital token) the process 300 proceeds to block 308. At block 308, the services layer system 102 generates and presents user interfaces for the acquisition transaction. For example, the services layer system 102 can cause the client service 104 to present a user interface for the user to fill out a form related to the transaction to collect basic information about the user, such as the user's name, address, contact information, etc. The services layer system 102 further causes the client service 104 to present a user interface to collect billing information, such as the type of payment. The same user interface or a separate user interface can be used to allow the user to confirm the acquisition of the digital token.

After receiving the confirmation of the acquisition, the process 300 proceeds to block 310, where the services layer system 102 determines if the user has a blockchain wallet associated therewith. If the user does not have a blockchain wallet, the process 300 proceeds to block 312, where the services layer system 102 communicates with the blockchain wallet management service 108 to have the blockchain wallet management service 108 create a blockchain wallet for the user. As discussed above, a blockchain wallet includes a public address and a private key. The services layer system 102 utilizes the private key of the created blockchain wallet to integrate the blockchain wallet with the blockchain-based resource management system 100. With this integration, no separate authentication for the blockchain wallet access is required and the services layer system 102 can operate on the blockchain wallet on the user's behalf. In addition, the blockchain wallet management service 108 stores the private key of the blockchain wallet in the user account or otherwise makes it accessible by the user. This allows the user to access the user's blockchain wallet even if the blockchain-based resource management system 100 is not available or no longer exists.

If the services layer system 102 determines at block 310 that the user already has a blockchain wallet, the process 300 proceeds to block 314 where the services layer system 102 obtains, for example, through the blockchain wallet management service 108, the information about the blockchain wallet of the user. This type of information can be obtained by the system prompting the user to provide the public address and the private key of the blockchain wallet. Alternatively, or additionally, the services layer system 102 can cause the client service 104 to detect if there is a third-party application for accessing blockchain wallets installed on the user's computing device. If so, the system can request a user to log into the third party application and pass the address and private key of the blockchain wallet to the blockchain-based resource management system 100. After obtaining the address and private key of the user's blockchain wallet, the services layer system 102 can have the information stored in the blockchain wallet management service 108 and integrate the blockchain wallet into the system to operate on the blockchain wallet on the user's behalf.

From block 312 or block 314, process 300 proceeds to block 316 where the services layer system 102 instructs the blockchain (e.g., the smart contract on the blockchain) to perform the transaction. The blockchain, or more specifically the smart contract on the blockchain, executes the transaction and transfers the requested digital object to the address of the blockchain wallet to reflect the acquisition of the digital token by the user. The smart contract returns a confirmation after the transaction is completed in the blockchain.

At block 318, the services layer system 102 receives the confirmation of the transaction from the blockchain and updates the information stored in the operational database 112 based on the transaction. For example, the owner list is updated to include the user as the owner of the digital object, and the address list is updated by adding the address of the blockchain wallet of the user. After the transaction is complete, the digital object is stored in his blockchain wallet and can be viewed anytime when the user is logged into the system. In some examples, acquiring the resource associated with a physical asset can lead to a change to the physical asset to reflect the resource being acquired. In those examples, the services layer system 102 can also generate a notification to request the physical asset to be processed. For instance, if the resource associated with a physical asset is the naming rights of the physical asset, after the resource is acquired, the physical asset can be processed by engraving or marking the physical asset to show the ownership of the naming rights.

Continuing the above example, a user acquiring the naming rights of a physical asset may also want to view the physical asset which can be achieved by the user submitting a request to view a 3D model of the physical asset. Referring back to FIG. 3, if the user request received at block 306 is a request to view the 3D model of a physical asset corresponding to the digital object that the user has acquired, the process 300 proceeds to block 320. At block 320, the services layer system 102 retrieves information associated with the physical asset corresponding to the digital object, such as the type of the physical asset, the shape of the physical asset, the color of the physical assets, or other information about the physical asset. The information can be obtained from, for example, the smart contract on the blockchain through the hyperledger fabric network 106. Alternatively, the services layer system 102 can obtain such information from the operational database 112 more efficiently. For example, the services layer system 102 can query the operational database 112 using the ID of the digital token to find the corresponding physical asset and its associated information. The services layer system 102 then sends the information about the physical asset to the 3D render widget 114.

At block 322, the services layer system 102 causes (e.g., requests) the 3D render widget 114 to generate the 3D model and the marker indicating the naming rights, if there is a marker associated with the physical object. The services layer system 102 then sends the generated 3D model to the client service 104 for presentation to the user on the user device. From block 322 and block 318, process 300 proceeds to block 324, where the services layer system 102 determines if the user requests exiting the blockchain-based resource management system 100. If not, process 300 proceeds to block 306 to receive a further request from the user; otherwise, process 300 terminates.

Although not described in FIG. 3, a user can check the digital objects in the user's blockchain wallet without requesting to view the 3D model. If the user submits such a request, the services layer system 102 can query the operational database 112 to determine the digital objects owned by the user and stored in the blockchain wallet of the user. In another example, the services layer system 102 retrieves the information about the digital objects owned by the user from the smart contract in the hyperledger fabric network 106. The services layer system 102 then causes the client service 104 to display such information to the user.

Resource Transfer

It should be understood that although the above description of FIG. 3 focuses on the acquisition of the digital token, transferring the digital token can be performed similarly. For example, the services layer system 102 can generate a user interface that allows a user to request the transfer of his digital token to another user. Upon receiving the request, the services layer system 102 determines if the second user has a blockchain wallet integrated with his account. If not, the services layer system 102 obtains the address and private key of the existing blockchain wallet of the user if he has one or to create a new blockchain wallet for the user as described above. If the second user has a blockchain wallet unlocked and integrated with his user account, the services layer system 102 calls the blockchain (e.g., the smart contract) in the hyperledger fabric network 106 to execute the transaction. The blockchain removes the digital token from the first user's blockchain wallet and adds it to the second user's blockchain wallet. After receiving the confirmation from the blockchain that the transaction is complete, the services layer system 102 updates the operational database 112 to reflect the transfer and displays a confirmation message in the user interface.

Crowd Acquisition

In some configurations, the blockchain-based resource management system 100 can also be configured to support resource acquisition by multiple parties. In this crowd acquisition, multiple users can collectively acquire the resource associated with the same physical asset. Depending on the way the acquisition is made, the resource (e.g., the naming rights) of the physical asset can be owned by a single user or jointly owned by multiple users. For example, a first user logs into the blockchain-based resource management system 100 through the client service 104 and requests to acquire the naming rights of a physical asset. Instead of putting all the amount required to acquire the naming rights (i.e., digital token corresponding to the physical asset) the user contributes a portion of the amount to the blockchain-based resource management system 100. In response, the services layer system 102 calls the blockchain or more specifically the smart contract in the hyperledger fabric network 106 to perform the transaction. The smart contract records that the portion of the amount is assigned to the blockchain wallet of the first user, but does not release the digital token to the first user's blockchain wallet. As a result, the digital token does not have significance in the blockchain-based resource management system 100 because the naming rights have not been completely acquired.

Subsequently, a second user, such as a friend of the first user, can log in and request to contribute to the acquisition of the same digital token. The second user can identify the digital token, for example, by browsing through the first user's blockchain wallet because the address of the blockchain wallet is public. The second user can select the digital token and contribute the remaining portion of the amount required to acquire the digital token. The services layer system 102 can be configured to allow the user to select to contribute the remaining portion of the amount to the first user. In response to such a contribution, the blockchain-based resource management system 100 automatically applies the contribution to the digital token without both users' further interaction with the blockchain-based resource management system 100. In this case, the first user owns the digital token solely and the smart contract moves the digital token to the blockchain wallet of the first user as described above.

In addition, the services layer system 102 can also be configured to allow the user to directly contribute to the digital token, in which case, the blockchain-based resource management system 100 will process the transaction in a way similar to that described above for the first user. As a result of this transaction, the digital token is owned by both users which is reflected in the token status stored in the smart contract and the operational database 112.

If there are more than two users, the blockchain-based resource management system 100 functions similarly as described above with regard to the case of two users. In either case, the smart contract will hold the digital token for the user(s) without determining the ownership of the digital token. The ownership is determined until a threshold amount, such as 40% of the total amount, has been contributed by a user (including the amount contributed by other users through him).

Burning a Digital Token

In some scenarios, a digital token may become invalid after being acquired by one or more users. This may be caused by, for example, the digital token being acquired by the users through fraud, such as using cryptocurrency obtained by hacking another user's account, the payment of the digital token being canceled or charged back, or other types of errors that result in the digital token becoming invalid. In these scenarios, the blockchain-based resource management system 100 is configured to burn or destroy the digital token so that the digital token is no longer meaningful in the system. To burn a digital token, the services layer system 102 determines if the resource associated with the physical asset corresponding to the digital token is reusable. For example, if the resource is naming rights of the physical object, this resource is reusable if the physical object has not been engraved or marked with the donor information. If the resource is not reusable, the services layer system 102 updates the operational database 112 to indicate that the physical asset associated with the digital token is a bad item or a damaged item so that it is no longer eligible for resource acquisition. The services layer system 102 further instructs the legacy asset management service 120 to add a new and similar item for resource acquisition. The asset information of the new item is then passed to the services layer system 102 and the smart contract in the hyperledger fabric network 106 to generate a new token for acquisition.

If the resource of the physical asset is reusable, the services layer system 102 requests the legacy asset management service 120 to issue a new asset ID for the physical asset as if the physical asset is a new item. The services layer system 102 passes the new asset ID to the smart contract to generate a new digital token for the physical asset. In either case, the operational database 112 is updated to reflect the change. The new digital token can be offered for acquisition as other digital tokens. Although the burnt digital token still exists in the smart contract, it becomes meaningless in the blockchain-based resource management system 100.

It should be understood that while the above description focuses on the hyperledger fabric network and the smart contract, other types of blockchain-based computing network, such as the ethereum network, and block-chain computing technologies can also be utilized to implement the resource management disclosed herein.

It should be further understood that while the above description focuses on the resource being the naming rights of physical items, the technologies presented herein can also be applied to any type of resources associated with physical items that can be tokenized and contracted against, such as season tickets, leasing (e.g. cars, apartments, computing servers, digital storage devices) and so on.

Computer System Example

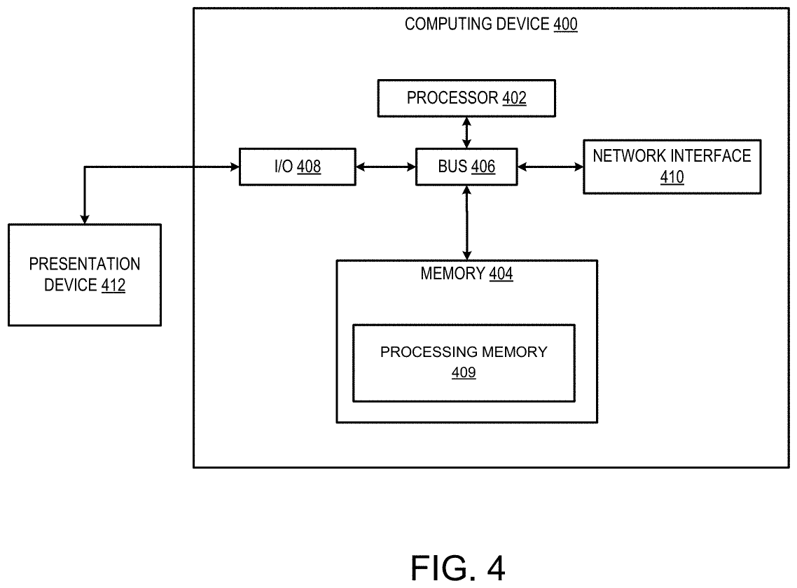

Any suitable computing system or group of computing systems can be used to perform the operations described herein. For example, FIG. 4 is a block diagram depicting an example of a computing device 400 that can be utilized to implement the various systems and services in the blockchain-based resource management system 100. The example of the computing device 400 can include various devices for communicating with other devices in the system 100, as described with respect to FIG. 1. The computing device 400 can include various devices for performing one or more of the operations described above with respect to FIGS. 1-3.

The computing device 400 can include a processor 402 that is communicatively coupled to a memory 404. The processor 402 executes computer-executable program code stored in the memory 404, accesses information stored in the memory 404, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others.

Examples of a processor 402 include a microprocessor, an application-specific integrated circuit, a field-programmable gate array, or any other suitable processing device. The processor 402 can include any number of processing devices. The processor 402 can include or communicate with a memory 404. The memory 404 stores program code that, when executed by the processor 402, causes the processor to perform the operations described in this disclosure.

The memory 404 can include any suitable non-transitory computer-readable medium. The computer-readable medium can include any electronic, optical, magnetic, or other storage devices capable of providing a processor with computer-readable program code or other program code. Non-limiting examples of a computer-readable medium include a magnetic disk, memory chip, optical storage, flash memory, storage class memory, a CD-ROM, DVD. ROM, RAM, an ASIC, magnetic tape or other magnetic storage, or any other medium from which a computer processor can read and execute program code. The program code may include processor-specific program code generated by a compiler or an interpreter from code written in any suitable computer-programming language.

The computing device 400 may also include a number of external or internal devices such as input or output devices. For example, the computing device 400 is shown with an input/output interface 408 that can receive input from input devices or provide output to output devices. A bus 406 can also be included in the computing device 400. The bus 406 can communicatively couple one or more components of the computing device 400.

The computing device 400 can execute program code that includes one or more of the systems and services in the blockchain-based resource management system 100. The program code for these systems or services may be resident in any suitable computer-readable medium and may be executed on any suitable processing device. Executing these systems or services can configure the processor 402 to perform the operations described herein. The systems or services can make use of processing memory 409 that is part of the memory of computing device 400.

In some aspects, the computing device 400 can include one or more output devices. One example of an output device is the network interface device 410 depicted in FIG. 4. A network interface device 410 can include any device or group of devices suitable for establishing a wired or wireless data connection to one or more data networks. Non-limiting examples of the network interface device 410 include an Ethernet network adapter, a modem, etc.

Another example of an output device is the presentation device 412 depicted in FIG. 4. A presentation device 412 can include any device or group of devices suitable for providing visual, auditory, or other suitable sensory output. Non-limiting examples of the presentation device 412 include a touchscreen, a monitor, a speaker, a separate mobile computing device, etc.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification that terms such as “processing,” “computing,” “calculating,” and “determining” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computing systems accessing stored software that programs or configures the computing system from a general purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device.

Aspects of the methods disclosed herein may be performed in the operation of such computing devices. The order of the blocks presented in the examples above can be varied—for example, blocks can be re-ordered, combined, or broken into sub-blocks. Certain blocks or processes can be performed in parallel.

The use of “configured to” herein is meant as open and inclusive language that does not foreclose devices configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific aspects thereof, it will be appreciated that those skilled in the art, upon attaining an understanding of the foregoing, may readily produce alterations to, variations of, and equivalents to such aspects. Any aspects or examples may be combined with any other aspects or examples. Accordingly, it should be understood that the present disclosure has been presented for purposes of example rather than limitation, and does not preclude inclusion of such modifications, variations, or additions to the present subject matter as would be readily apparent to one of ordinary skill in the art.

1. A secure resource management system, comprising:
a blockchain-based computing network configured to host a blockchain, the blockchain configured for:
generating, based on information about a physical object, a digital object to represent a resource associated with the physical object; and
responsive to a transfer request, transferring the digital object to a secure network address associated with a user indicated in the transfer request:
a database configured for storing at least identifiers of digital objects created by the blockchain-based computing network along with information about respective physical objects; and
a services layer system communicatively coupled to the blockchain-based computing network and the database and configured for performing operations comprising:
sending information about the physical object to the blockchain in the blockchain-based computing network to request the digital object to be generated;
receiving, from the blockchain, an identifier of the digital object created on the blockchain;
storing the identifier of the digital object in the database along with the information about the physical object;
receiving, through a user interface presented on a user computing device associated with a user, a request for obtaining the digital object by the user;
in response to receiving the request, sending a transfer request to the blockchain to cause the blockchain to transfer the digital object to a secure network address associated with the user; and
updating the database to indicate that the digital object is assigned to the user.

2. The secure resource management system of claim 1, wherein the operations further comprise:
prior to sending the transfer request to the blockchain, determining if a secure network address has been allocated to the user;
in response to determining that a secure network address has not been allocated to the user, causing a secure network address to be created for the user; and
in response to determining that a secure network address has been allocated to the user, obtaining the secure network address and a private key associated with the secure network address.

3. The secure resource management system of claim 2, wherein the secure network address associated with the user is a blockchain wallet of the user.

4. The secure resource management system of claim 1, wherein the blockchain comprises a smart contract and the digital object is created by the smart contract on the blockchain, and wherein the blockchain is accessible via a representational state transfer (RESTful) service abstraction layer.

5. The secure resource management system of claim 1, wherein the resource associated with the physical object comprises naming rights of the physical object.

6. The secure resource management system of claim 1, wherein the operations further comprise:
receiving a request to view digital objects assigned to the user;
retrieving data indicating the digital objects assigned to the user from one or more of the database or the blockchain; and
causing the retrieved data to be presented in the user interface on the user computing device.

7. The secure resource management system of claim 1, wherein the operations further comprise:
determining that the digital object is invalid;
requesting the blockchain to generate a new digital object to represent the resource associated with the physical object on the blockchain;
receiving an identifier of the new digital object created on the blockchain; and
updating the database to add the identifier of the new digital object as a valid digital object and mark the digital object as invalid.

8. The secure resource management system of claim 7, wherein the operations further comprise:
retrieving a list of identifiers for valid digital objects from the database; and
causing the list of identifiers for the valid digital objects to be presented in the user interface, wherein the request for obtaining the digital object is generated in response to the user selecting the identifier of the digital object from the list of identifiers.

9. The secure resource management system of claim 1, further comprising:
a wallet management service configured for creating and managing secure network addresses for users of the secure resource management system.

10. A method that includes one or more processing devices performing operations comprising:
sending information about a physical object to a blockchain to cause a digital object to be created to represent a resource associated with the physical object on the blockchain;
receiving an identifier of the digital object created on the blockchain;
storing the identifier of the digital object in a database along with the information about the physical object;
receiving, through a user interface presented on a user computing device associated with a user, a request for obtaining the digital object by the user;
in response to receiving the request, causing the blockchain to transfer the digital object to a secure network address associated with the user; and
updating the database to indicate that the digital object is assigned to the user.

11. The method of claim 10, further comprising:
prior to causing the blockchain to transfer the digital object, determining if a secure network address has been allocated to the user;
in response to determining that a secure network address has not been allocated to the user, causing a secure network address to be created for the user; and
in response to determining that a secure network address has been allocated to the user, obtaining the secure network address and a private key associated with the secure network address.

12. The method of claim 11, wherein the secure network address associated with the user is a blockchain wallet of the user.

13. The method of claim 10, wherein the blockchain comprises a smart contract and the digital object is created by the smart contract on the blockchain.

14. The method of claim 10, wherein the resource associated with the physical object comprises naming rights of the physical object.

15. The method of claim 10, further comprising:
receiving a request to view digital objects assigned to the user;
retrieving data indicating the digital objects assigned to the user from one or more of the database or the blockchain; and
causing the retrieved data to be presented in the user interface on the user computing device.

16. The method of claim 10, further comprising:
determining that the digital object is invalid;
causing a new digital object to be created to represent the resource associated with the physical object on the blockchain;
receiving an identifier of the new digital object created on the blockchain; and
updating the database to add the identifier of the new digital object as a valid digital object and mark the digital object as invalid.

17. The method of claim 16, further comprising:
retrieving a list of identifiers for valid digital objects from the database; and
causing the list of identifiers for the valid digital objects to be presented in the user interface, wherein the request for obtaining the digital object is generated in response to the user selecting the identifier of the digital object from the list of identifiers.

18. A system, comprising:
one or more processing devices;
a non-transitory computer-readable storage medium communicatively coupled to the processing device, wherein the one or more processing devices are configured to execute program code stored in the non-transitory computer-readable storage medium and thereby perform operations comprising:
sending information about a physical object to a blockchain to cause a digital object to be created to represent a resource associated with the physical object on the blockchain;
receiving an identifier of the digital object created on the blockchain;
storing the identifier of the digital object in a database along with the information about the physical object;
receiving, through a user interface presented on a user computing device associated with a user, a request for obtaining the digital object by the user;
in response to receiving the request, causing the blockchain to transfer the digital object to a secure network address associated with the user; and
updating the database to indicate that the digital object is assigned to the user.

19. The non-transitory computer-readable storage medium of claim 18, wherein the operations further comprise:
prior to causing the blockchain to transfer the digital object, determining if a secure network address has been allocated to the user;
in response to determining that a secure network address has not been allocated to the user, causing a secure network address to be created for the user; and
in response to determining that a secure network address has been allocated to the user, obtaining the secure network address and a private key associated with the secure network address.

20. The non-transitory computer-readable storage medium of claim 18, wherein the blockchain comprises a smart contract and the digital object is created by the smart contract on the blockchain.
